(19) United States
(12) Patent Application Publication
(10) Pub. No.: US 2015/0242009 A1
(43) Pub. Date: Aug. 27, 2015

(54) Using Capacitive Images for Touch Type Classification

(71) Applicant: Qeexo, Co., San Jose, CA (US)

(72) Inventors: Robert Bo Xiao, Pittsburgh, PA (US); Greg Lew, Pittsburgh, PA (US); Julia Schwarz, Pittsburgh, PA (US); Christopher Harrison, Pittsburgh, PA (US)

(73) Assignee: Qeexo, Co., San Jose, CA (US)

(21) Appl. No.: 14/191,329

(22) Filed: Feb. 26, 2014

(51) Int. Cl. G06F 3/044; G06F 3/0488; G06K 9/00; G06F 3/043

(52) U.S. Cl. CPC G06F 3/044; G06F 3/0433; G06F 3/04883; G06K 9/00375; G06F 2203/04106; G06F 2203/04808

(57) ABSTRACT

An electronic device includes a touch-sensitive surface, for example a touch pad or touch screen. The user physically interacts with the touch-sensitive surface, producing touch events. The resulting interface actions taken depend at least in part on the touch type. The type of touch is determined in part based on capacitive image data produced by the touch event.

### BACKGROUND OF THE INVENTION

1. Field of the Invention

This invention relates generally to interacting with electronic devices via a touch-sensitive surface.

2. Description of the Related Art

Many touch pads and touch screens today are able to support a small set of gestures. For example, one finger is typically used to manipulate a cursor or to scroll the display. Another example is using two fingers in a pinching manner to zoom in and out of content, such as a photograph or map. However, this is a gross simplification of what fingers and hands are capable of doing. Fingers are diverse appendages, both in their motor capabilities and their anatomical composition. Furthermore, fingers and hands can also be used to manipulate tools, in addition to making gestures themselves.

Thus, there is a need for better utilization of the capabilities of fingers and hands to control interactions with electronic devices.

### SUMMARY

The present invention allows users to interact with touch-sensitive surfaces in a manner that distinguishes different touch types. For example, the same touch events performed by a finger pad, a finger nail, a knuckle or different types of instruments may result in the execution of different actions on the electronic device.

In one approach, a user uses his finger(s) or an instrument to interact with an electronic device via a touch-sensitive surface, such as a touch pad or a touch screen based on capacitive sensing (e.g., projective capacitive, mutual capacitance). The electronic device based on capacitive sensing often uses an arrangement of electrodes to sense capacitance at multiple locations on the touch-sensitive surface. The information from these electrodes form a two dimensional representation (a “capacitive image”) that includes capacitance measurements taken at each location of the electrode arrangement. The capacitive image is typically computed inside a touch sensor of the electronic device, but other chips or locations associated with the electronic device for generating the capacitive image are possible.

The capacitive image can be used to determine the location of touch inputs (potentially, multiple touch inputs, e.g., “multi-touch”). The capacitive image can also be used to derive a series of features. These features can then be passed to a classification engine which uses these features to determine touch types. For example, the classification engine determines whether a fingertip, knuckle, fingernail, stylus, eraser or other instrument has been used to touch the surface of the electronic device.

In an alternative approach, other touch data are also passed to the classification engine along with the features derived from the capacitive image. For example, this other touch data can include position and touch size detected by other sensors of the electronic device. Features can further be extracted from the touch data and used to determine touch type in combination with the features derived from the capacitive image. For example, these features extracted based upon touch data can be from acoustic sensors, vibro-acoustic sensors, accelerometers, gyroscopes, microphones, magnetometers, barometers, etc. In one exemplary embodiment, these features as well as the features from the capacitive image are processed by multiple classifiers to generate multiple results and the multiple results are combined in a voting manner to determine the type of the touch event.

In another aspect, the touch type can be reported to applications running on a computing platform of the electronic device, which can make use of the touch type information. Accordingly, an action is taken on the electronic device in response to the touch type. That is, different types of touches can result in execution of different actions.

Other aspects of the invention include methods, devices, systems, components and applications related to the approaches described above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram of an electronic device according to the present invention.

FIG. 2 is a flow diagram illustrating touch event analysis using the device of FIG. 1.

FIG. 3 is a diagram illustrating four types of finger touches.

FIG. 4 is a spectrogram of the four types of finger touches shown in FIG. 3.

FIG. 5 is a diagram illustrating a capacitive image and derivative images.

FIG. 6 is a diagram illustrating various parts of a finger.

FIG. 7 is a diagram illustrating a finger and various tools for the device of FIG. 1.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

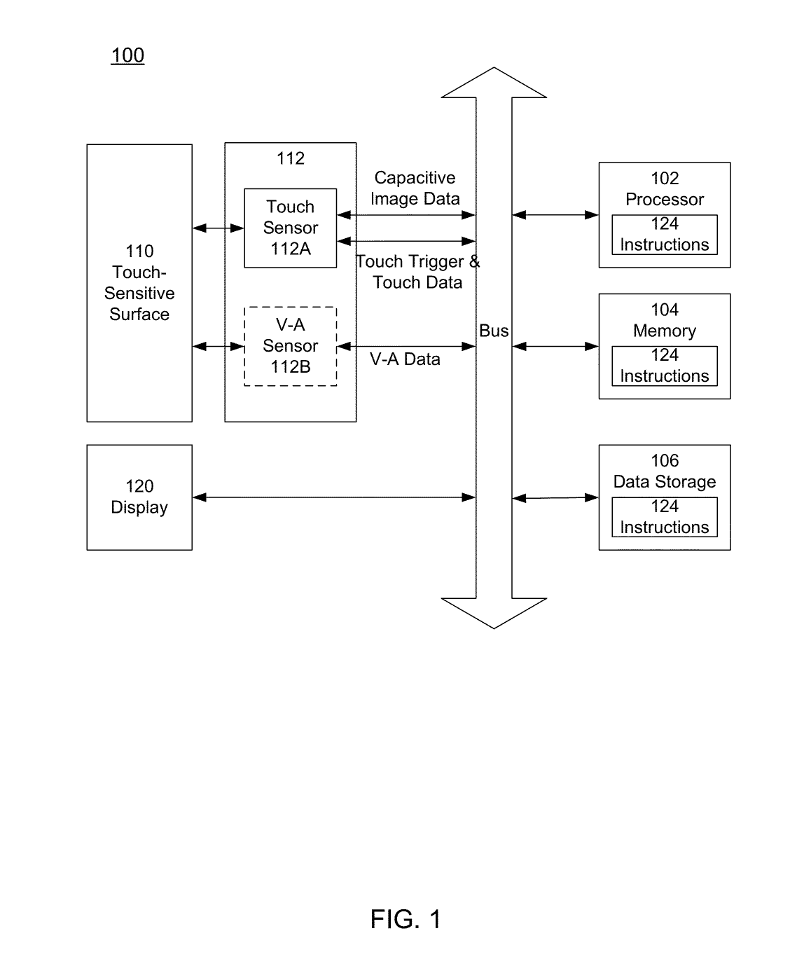

FIG. 1 is a block diagram of an electronic device 100 according to the present invention. The device 100 includes a touch-sensitive surface 110, for example a touch pad or touch screen. It also includes computing resources, such as processor 102, memory 104 and data storage 106 (e.g., an optical drive, a magnetic media hard drive or a solid state drive). Sensor circuitry 112 provides an interface between the touch-sensitive surface 110 and the rest of the device 100. Instructions 124 (e.g., software), when executed by the processor 102, cause the device to perform certain functions. In this example, instructions 124 include a touch analysis module that analyzes the user interactions with the touch-sensitive surface 110. The instructions 124 also allow the processor 102 to control a display 120 and to perform other actions on the electronic device 100.

In a common architecture, the data storage 106 includes a machine-readable medium which stores the main body of instructions 124 (e.g., software). The instructions 124 may also reside, completely or at least partially, within the memory 104 or within the processor 102 (e.g., within a processor's cache memory) during execution. The memory 104 and the processor 102 also constitute machine-readable media.

In this example, the different components communicate using a common bus, although other communication mechanisms could be used. As one example, the processor 102 could act as a hub with direct access or control over each of the other components.

The device 100 may be a server computer, a client computer, a personal computer (PC), or any device capable of executing instructions 124 (sequential or otherwise) that specify actions to be taken by that device. Further, while only a single device is illustrated, the term “device” shall also be taken to include any collection of devices that individually or jointly execute instructions 124 to perform any one or more of the methodologies discussed herein. The same is true for each of the individual components. For example, the processor 102 may be a multicore processor, or multiple processors working in a coordinated fashion. It may also be or include a central processing unit (CPU), a graphics processing unit (GPU), a network processing unit (NPU), a digital signal processor (DSP), one or more application specific integrated circuits (ASICs), or combinations of the foregoing. The memory 104 and data storage 106 may be dedicated to individual processors, shared by many processors, or a single processor may be served by many memories and data storage.

As one example, the device 100 could be a self-contained mobile device, such as a cell phone or tablet computer with a touch screen. In that case, the touch screen serves as both the touch-sensitive surface 110 and the display 120. As another example, the device 100 could be implemented in a distributed fashion over a network. The processor 102 could be part of a cloud-based offering (e.g., renting processor time from a cloud offering), the data storage 106 could be network attached storage or other distributed or shared data storage, and the memory 104 could similarly be distributed or shared. The touch-sensitive surface 110 and display 120 could be user I/O devices to allow the user to interact with the different networked components.

Returning to FIG. 1, the sensor circuitry 112 includes touch sensor 112A. The touch sensor 112A senses the touch contact caused by the user with the touch-sensitive surface 110. For example, the touch-sensitive surface may be based on capacitive, optical, resistive, electric field, acoustic or other technologies that form the underlying basis for the touch sensing. The touch sensor 112A includes the components that sense the selected phenomenon.

In the case that the touch-sensitive surface 110 is based on capacitive sensing (e.g., projected capacitive, mutual capacitance), the touch sensor 112A may often use an arrangement of electrodes to sense capacitance at multiple locations on the touch-sensitive surface 110. For example, the touch-sensitive surface 110 may include a grid of horizontal and vertical electrodes (“lines” or “electrode lines”). The touch sensor 112A measures the capacitance at each intersection of the “lines.” In this way, the touch sensor 112A creates a two-dimensional (2D) capacitance profile, which is referred to as a “capacitive image.” Accordingly, a capacitive image includes capacitive signals corresponding to capacitances measured at a plurality of locations on the touch-sensitive surface 110 (e.g., intersections of lines). In the above example, the capacitive image is a 2D grid of capacitance values. The capacitive image includes image points corresponding to the intersections of the horizontal and vertical electrodes lines, and values at the image points corresponding to the capacitances measured at the intersections. The underlying grid is not required to be rectilinear. Any arrangement of electrodes in which the capacitance is sampled at various locations on the touch-sensitive surface 110 can give rise to a 2D capacitive image. For example, it is possible that the touch sensor 112A extracts an image from a sensing arrangement using lines running diagonally across the surface 110 (e.g., at a 45 degree angle to the edges of the surface 110).

The capacitances measured at locations of the touch-sensitive surface 110 vary in response to a touch event (e.g., a physical touch) on the touch-sensitive surface 110. Further, a touch event may correspond to a plurality of locations of the touch-sensitive surface 110 and thus affect a plurality of capacitances measured at the plurality of locations. For example, capacitances sampled at locations where a physical touch occurs may be different from capacitances sampled at other locations where no physical touch occurs. Moreover, in response to different types of touch event occurring on the touch-sensitive surface 110, the capacitances measured may be different. The generated capacitive image, including the capacitances measured at multiple locations of the touch-sensitive surface 110, can be used to analyze and classify touch events.

The touch sensor circuitry 112A may also produce a touch event trigger, which indicates the occurrence of a touch event. Touch event triggers could appear in different forms. For example, the touch event trigger might be an interrupt from a processor controlling the touch sensing system. Alternately, the touch event trigger could be a change in a polled status of the touchscreen controller. It could also be implemented as a modification of a device file (e.g., “/dev/input/event6”) on the file system, or as a message posted to a driver work queue. As a final example, the touch event trigger could be implemented as an onTouchDown( ) event in a graphical user interface program.

The sensor circuitry 112 can optionally include vibro-acoustic sensor 112B or other types of sensors, as depicted using dashed line in FIG. 1. In many situations, touching the surface may cause acoustic signals (such as the sound of a fingernail or finger pad contacting glass) and/or may cause vibrations in the underlying structure of an electronic device, e.g., chassis, enclosure, electronics boards (e.g., PCBs). The sensor circuitry 112 optionally includes sensors 112B to detect the vibro-acoustic signals. Examples of vibro-acoustic sensors include impact sensors, vibration sensors, accelerometers, strain gauges, and acoustic sensors such as a condenser microphone, a piezoelectric microphone, MEMS microphone and the like. The vibro-acoustic signals may be used along with the capacitive images to determine types of touch events.

Whatever the underlying principle of operation, touches on the touch-sensitive surface 110 will result in signals—both 2D capacitive image signals and possibly also vibro-acoustic or other signals. However, these raw signals typically are not directly useable in a digital computing environment. For example, the signals may be analog in nature. The sensor circuitry 112A-B typically provides an intermediate stage to process and/or condition these signals so that they are suitable for use in a digital computing environment. As shown in FIG. 1, the touch sensor circuitry 112A produces the capacitive image data for subsequent processing and the circuitry 112B produces data from other modalities for subsequent processing.

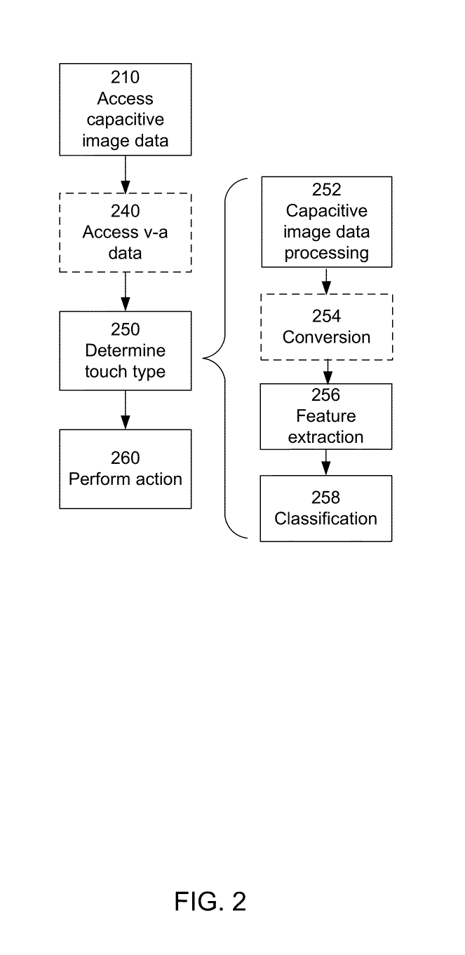

FIG. 2 is a flow diagram illustrating a touch event using device 100. The user uses his finger(s) or other instruments to interact with the touch-sensitive surface 110. For example, he may use his finger to touch an element displayed on the device, or to touch-and-drag an element, or to touch-and-drag his finger over a certain region. These interactions are meant to instruct the electronic device 100 to perform corresponding actions. The device 100 accesses 210 capacitive image data generated by the touch-sensitive surface 110 and sensor circuitry 112 in response to the touch event, as one example. In such a case, the device 100 may receive from the touch sensor 112A the capacitive image data in response to the touch event (e.g., a physical touch) on the touch-sensitive surface 110 detected by other sensors (e.g., sensors based on optical technology, etc.). As another example, the device 100 may access 210 the capacitive image data without detecting any touch event. The capacitive image data itself can be used to determine occurrence of a touch event. The device 100 optionally accesses 240 vibro-acoustic or other data produced by the touch event. The capacitive image data and possibly other data are used to determine 250 a touch type for the touch event.

Touch types can be defined according to different criteria. For example, different touch types can be defined depending on the number of contacts. A “uni-touch” occurs when the touch event is defined by interaction with a single portion of a single finger (or instrument), although the interaction could occur over time. Examples of uni-touch include a simple touch (e.g., a single tap), touch-and-drag, and double-touch (e.g., a double-tap—two taps in quick succession). In multi-touch, the touch event is defined by combinations of different fingers or finger parts. For example, a touch event where two fingers are simultaneously touching is a multi-touch. Another example would be when different parts of the same finger are used, either simultaneously or over time.

Touch types can also be classified according to which part of the finger or instrument touches. For example, touch by the finger pad, finger nail or knuckle could be considered different touch types. The finger pad is the fleshy part around the tip of the finger. It includes both the fleshy tip and the fleshy region from the tip to the first joint. The knuckle refers to any of the finger joints. The term “finger” is also meant to include the thumb. It should be understood that the finger itself is not required to be used for touching; similar touches may be produced in other ways. For example, the “finger pad” touch type is really a class of touch events that have similar characteristics as those produced by a finger pad touching the touch-sensitive surface, but the actual touching object may be a man-made instrument or a gloved hand or covered finger, so long as the touching characteristics are similar enough to a finger pad so as to fall within the class.

The touch type is determined in part by a classification of extracted features from the capacitive image (hereinafter, referred to as “capacitive features”) in response to the touch event. The capacitive features can be used alone or in combination with features derived from other sensor data to determine the touch type. The other sensor data can include data from acoustic sensors, vibro-acoustic sensors, accelerometers, gyroscopes, microphones, magnetometers, barometers, etc. For example, the touch type is determined in part by a classification of features from the capacitive image as well as features from vibro-acoustic signals from the touch event. When an object strikes a certain material, vibro-acoustic waves propagate outward through the material or along the surface of the material. As such, when respective finger parts touch or contact the surface of the touch-sensitive surface 110, vibro-acoustic responses are produced. The vibro-acoustic characteristics of the respective finger parts are unique, mirroring their unique anatomical compositions.

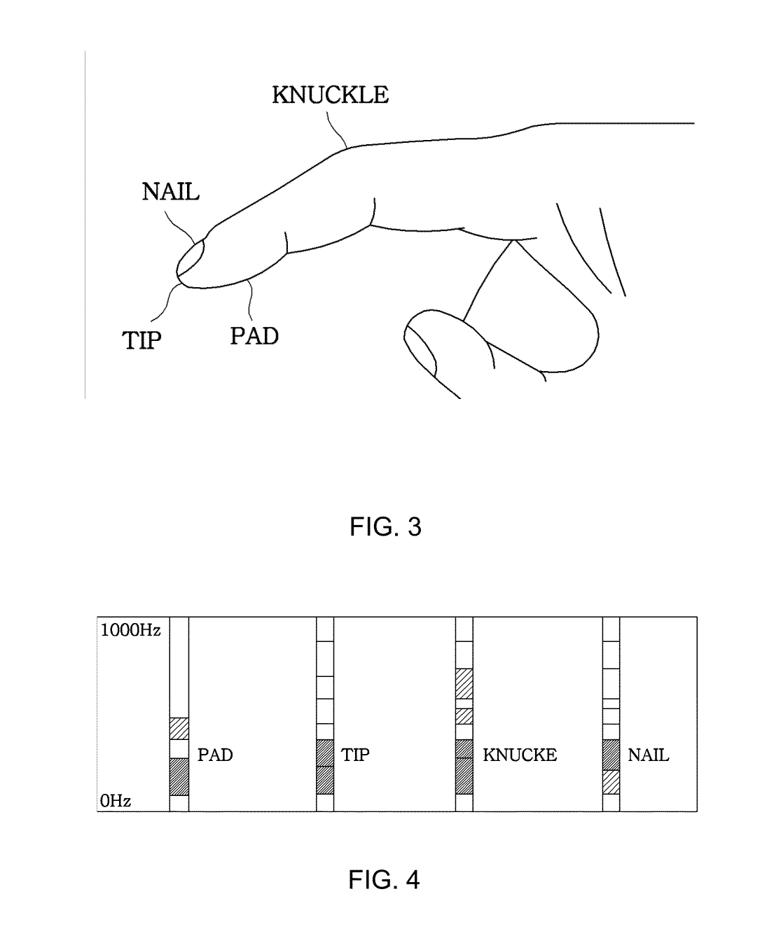

For example, FIG. 3 illustrates four different types of finger touches. As shown in FIG. 3, four parts of a finger include fingertip, finger pad, knuckle, and finger nail, which correspond to four types of finger touches. Different parts of a finger can produce different capacitive responses and therefore by capturing and analyzing capacitive image data (mostly implemented as part of instructions 124 in FIG. 1) the types of finger touches can be determined. Similarly, the finger tip, finger pad, knuckle, and finger nail also produce different vibro-acoustic responses. FIG. 4 illustrates an example vibro-acoustic spectrogram of the four types of finger touches. Tapping on different materials, with different fingers/finger parts, with different microphones, in different circumstances can result in different spectrograms. Once the vibro-acoustic signal has been captured, it can be processed along with the capacitive image data to determine the touch type.

FIG. 2 also shows a block diagram of an example touch analysis module 250. It includes capacitive image data processing 252, conversion 254, feature extraction 256, and classification 258. The capacitive image data processing module 252 processes capacitive image data. As one example, the capacitive image data processing module 252 removes noise or systematic errors from the capacitive image data. The noise or systematic errors can come from a variety of sources including, for example, systematic biases on an electrode line, ambient electrical, mechanical and environmental noise, etc. Accordingly, the capacitive image data processing module 252 may apply various filtering modes to the image data to reduce noise. For example, the capacitive image data processing module 252 subtracts from the capacitive image data a previously-stored background capacitive image data profile (e.g., a calibration profile obtained at device power-on time or by factory calibration). Other example filtering modes include, but not limited to, detecting noisy electrode lines (e.g., by applying a noise threshold onto each line) and removing the noise values; standard image filtering operations, such as, blur, box convolve, edge deletion or detection, image morphological operations (e.g., erode, dilate, open, close), contrast or brightness adjustment; etc.

The capacitive image data processing module 252 can also process the capacitive image data to extract locations corresponding to the physical touches on the touch-sensitive surface 110. For example, the capacitive image data processing module 252 extracts a region of the capacitive image data representing a physical touch on the touch-sensitive surface 110. The region includes capacitive image data for the location where the physical touch occurs. Such processing may be typically performed by the touch sensor 112A in the touch circuitry 112. However, it can be recognized that other component of the device 100 can also perform such or similar processing to extract the region of a physical touch. After a specific region of the capacitive image data corresponding to a single physical touch is identified, the capacitive image data processing module 252 may crop or isolate the specific region from regions representing other physical touches. As one example, the touch sensor 112A reports a touch position (e.g., a touch ellipse) based on touch data and the processing module 252 extracts a region of the capacitive image data corresponding to the touch ellipse. As another example, the processing module 252 uses a flood-filling algorithm to extract significant values near an initial seed point (e.g., gathered from peak analysis or from a touch position reported by the touch sensor 112A).

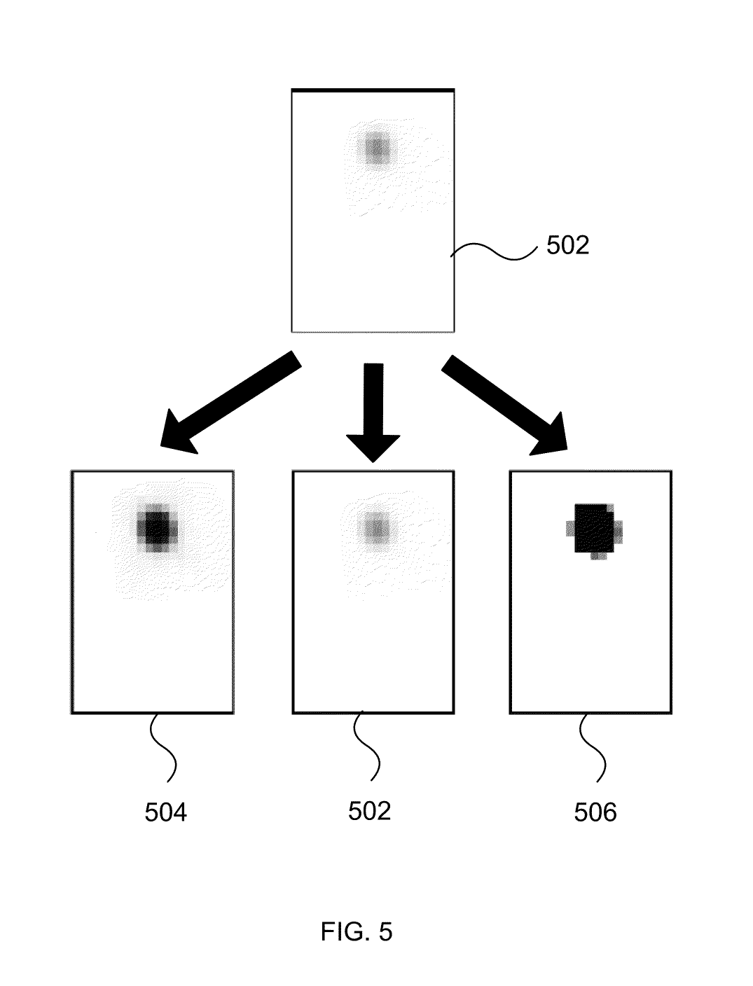

The capacitive image data processing module 252 can also perform transform on the capacitive image data to reveal additional informational content or to facilitate further processing of the image data. For example, the capacitive image data processing module 252 applies log transform on the capacitive image data to increase contrast and improve algorithmic sensitivity to small differences in the capacitive image. Through various transformations, the capacitive image data processing module 252 can obtain a number of derivative images from the capacitive image data, as shown in FIG. 5. FIG. 5 illustrates an original capacitive image 502 and derivative images 504, 506 derived from the original capacitive image 502. Examples of the transformations can include, but not limited to, log transform, adaptive thresholding, binarization, image morphological operations (e.g., erosion, dilation), convolution with blur, box, edge, Gaussian kernels, etc. In particular, the capacitive image data processing module 252 can filter the capacitive image data so that all values not corresponding to the physical touch are set to zero. Values corresponding to the physical touch itself are referred to hereinafter, as “nonzero values.”

The capacitive image data processing module 252 can also isolate the region of the capacitive image data in each derived image using the aforementioned region extraction procedure. For sake of conciseness and convenience, the derivation of the capacitive image in which the region corresponding to the physical touch has been isolated is referred to hereinafter, as “derivative touch image data.”

The conversion module 254 is optional as depicted using dashed line in FIG. 2. The conversion module 254 performs a frequency domain transform (e.g., a Fourier transform or method) on the sampled time-dependent vibro-acoustic signal in the buffer. For example, the Fourier transform of this window may produce 2048 bands of frequency power. The conversion module 254 may also perform other functions. These could include filtering the waveform (e.g., Kalman filter, exponential moving average, 2 kHz high pass filter, One Euro filter, Savitzky-Golay filter). It could also include transformation into other representations (e.g., wavelet transform, derivative), including frequency domain representations (e.g., spectral plot, periodogram, method of averaged periodograms, Fourier transform, least-squares spectral analysis, Welch's method, discrete cosine transform (DCT), fast folding algorithm).

The feature extraction module 256 then generates various features from the processed capacitive image data as well as possibly other sensor data, including vibro-acoustic signals and other touch data. In one embodiment, the feature extraction module 256 computes a number of features based on the derivative touch image data. As one example, the feature extraction module 256 computes covariance matrix of the image points in the derivative touch image data. The values of this covariance matrix are obtained as features. In addition, the ratio of each element of the covariance matrix to the total variance, and eigenvalues of covariance matrix can be obtained as features. As another example, the feature extraction module 256 extracts various-sized neighborhoods around the touch contact origin of the physical touch from the derivative touch image data. The various-sized neighborhoods can be regions including various numbers of points in the derivative touch image data. The sizes of the neighborhoods can include, but not limited to, for example, 5×5 points, 7×7 points, 9×9 points, 11×11 points, etc. The feature extraction module 256 then computes statistical features over these neighborhoods. The statistical features can include, but not limited to, mean, range, standard deviation, dispersion, skewness, root mean square (RMS), etc. Additionally, a vector of individual values in the derivative touch image data may also be used as a set of features. The individual values in the vector can be sorted by a comparison function. The total sum of individual values in the derivative touch image data can also be used as a feature.

Furthermore, the feature extraction module 256 may fit a multivariate Gaussian function over the distribution of the values in the derivative touch image data. This can be done through an expectation-maximization algorithm or by simple sample-weighting estimates. The feature extraction module 256 then computes features associated with the Gaussian function. These features can include magnitude (weight) of the Gaussian function relative to the mathematical normalized Gaussian function, value of the Gaussian function at the touch contact origin, and statistics on the covariance matrix of the Gaussian function.

The number of nonzero values in the derivative image data can be used as a simple estimation of the touch contact area. A similar value is commonly reported as “pressure” in many touch sensors. The sum of these nonzero values can be used as a feature. The feature extraction module 256 also compute statistical features, such as those previously computed from extracted neighborhoods, over these nonzero values.

The feature extraction module 256 can also compute shape features based on the derivative touch image data. For example, the feature extraction module 256 extracts a boundary around the touch region using contour analysis and then computes features based on the boundary. These features can include, but not limited to, average contour turning angle, contour perimeter, contour area, etc.

Optionally, the feature extraction module 256 can also extract features from other sensor data. For example, these features can include time domain and/or frequency domain representations of the vibro-acoustic signal (or its filtered versions), as well as first, second, and higher order derivatives thereof. These features can also include down-sampling the time and frequency domain data into additional vectors (e.g., buckets of ten), providing different aliasing. Additional vibro-acoustic features include linear prediction-based cepstral coefficients (LPCC), perceptual linear prediction (PLP) cepstral coefficients, cepstrum coefficients, mel-frequency cepstral coefficients (MFCC), and frequency phases (e.g., as generated by an FFT).

The feature extraction module 256 can also generate features from the touch data. Examples include location of the touch (2D, or 3D in the case of curved glass or other non-planar geometry), size and shape of the touch (some touch technologies provide an ellipse of the touch with major and minor axes, eccentricity, and/or ratio of major and minor axes), orientation of the touch, surface area of the touch (e.g., in squared mm or pixels), number of touches, pressure of the touch (available on some touch systems), and shear of the touch. For example, the touch ellipse is also used by other module (such as the processing module 252) to process the capacitive image data as described above with reference to the processing module 252. Another possible feature is an image of the hand pose (as imaged by e.g., an optical sensor, diffuse illuminated surface with camera, near-range capacitive sensing).

The classification module 258 classifies the touch event using extracted features from the capacitive image data as well as possibly other non-capacitive sensor features, including vibro-acoustic features and touch data features. Additionally, conventional touch information is also passed to the classification module 258. For example, many touch sensors provide touch position in X/Y coordinate, major and minor axes, size, pressure and many other attributes regarding a physical touch. These features can also be classified by the classification module 258 to determine a touch type of the touch event.

The classification module 258 can use a large number of approaches, including, but not limited to, basic heuristics, decision trees, support vector machine, random forest, naïve Bayes, elastic matching, template matching, k-means clustering, k-nearest neighbors algorithm, neural network, multilayer perception, multinomial logistic regression, Gaussian mixture models, AdaBoost, logistic boosting (LogitBoost), etc. In addition, the classification module 258 can also combine results from several different classifiers through, for example, a voting scheme. Moreover, the classification module 258 can use different classifiers based on different features. For example, two classifiers can be employed, one for classifying touch events with small contact areas, and another for classifying touch events with large contact areas. To aid classification, the user can provide supplemental training samples to the classifiers.

In one exemplary embodiment, to reduce computation time both for creating the classifier and evaluating the classifier, the classification module 258 can optionally apply an attribute selection process to reduce the set of features used in classification to only those with the highest discriminatory power. The attribute selection process can be based on a variety of approaches, including, for example, forward subset evaluation, information gain, support vector machine (SVM) weight analysis, etc.

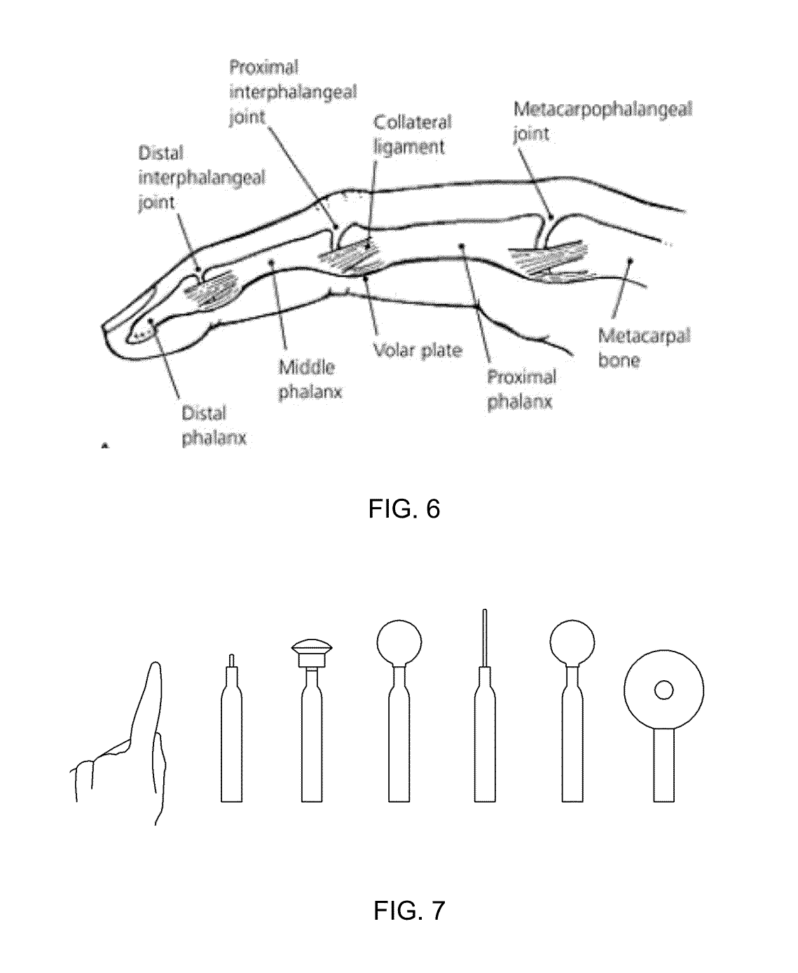

FIG. 6 illustrates more parts of a finger. As shown in FIG. 6, fingertip includes the fleshy mass on the palmar aspect of the extremity of the finger, as well as the finger sides up to the distal interphalangeal articulation. It also includes the very tip of the finger (i.e., the distal tip of the distal phalanx). However, the nail is not included as part of the fingertip definition, as this is an anatomically distinct feature and region. The nail encompasses all parts of the keratin (or artificial nail material), a horn-like envelope covering the dorsal aspect of the terminal phalanges of fingers. The knuckle includes the immediate areas surrounding the bony joints of human fingers, including joints on the thumb, and both major and minor knuckles. Specifically, the bony regions within a one centimeter radius surrounding the metacarpophalangeal joints and interphalangeal articulations. FIG. 7 illustrates a finger and various passive tools that can be used as touch tools. A passive tool does not require power to be used as a touch tool. As illustrated in FIG. 7, the six passive tools have different materials affixed to their tips, such as from left to right, a polycarbonate nub, wood knob, acrylic ball, metal screw, ping-pong ball, and foam. These different finger parts and passive tools can be used as touch tools to produce different types of touches.

Returning to FIG. 2, the device analyzes the touches to determine 250 the touch type. Based on this analysis, the processor 102 then performs 260 the appropriate actions. The appropriate action depends on the touch event (e.g., touch, touch-and-drag, etc.) but it also depends on the touch type of the touch event. The same touch event can result in different actions by processor 102, for different touch types. For example, a touch by the finger pad, a touch by the finger nail and a touch by an instrument may trigger three different actions.

This approach allows the same touch event to control more than one action. This can be desirable for various reasons. First, it increases the number of available actions for a given set of touch events. For example, if touch types are not distinguished, then a single tap can be used for only one purpose, because a single tap by a finger pad, a single tap by a finger nail and a single tap by an instrument cannot be distinguished. However, if all three of these touch types can be distinguished, then a single tap can be used for three different purposes, depending on the touch type.

Conversely, for a given number of actions, this approach can reduce the number of user inputs needed to reach that action. Continuing, the above example, if three actions are desired, by distinguishing touch types, the user will be able to initiate the action by a single motion—a single tap. If touch types are not distinguished, then more complex motions or a deeper interface decision tree may be required. For example, without different touch types, the user might be required to first make a single tap to bring up a menu of the three choices. He would then make a second touch to choose from the menu.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

The term “module” is not meant to be limited to a specific physical form. Depending on the specific application, modules can be implemented as hardware, firmware, software, and/or combinations of these. Furthermore, different modules can share common components or even be implemented by the same components. There may or may not be a clear boundary between different modules.

Depending on the form of the modules, the “coupling” between modules may also take different forms. Dedicated circuitry can be coupled to each other by hardwiring or by accessing a common register or memory location, for example. Software “coupling” can occur by any number of ways to pass information between software components (or between software and hardware, if that is the case). The term “coupling” is meant to include all of these and is not meant to be limited to a hardwired permanent connection between two components. In addition, there may be intervening elements. For example, when two elements are described as being coupled to each other, this does not imply that the elements are directly coupled to each other nor does it preclude the use of other elements between the two.

What is claimed is:

1. A method of interaction between a user and an electronic device having a touch-sensitive surface, the method comprising:
accessing a capacitive image comprising capacitive image data corresponding to capacitances at a plurality of locations on the touch-sensitive surface, the capacitances varying in response to a physical touch on the touch-sensitive surface;
processing the capacitive image data; and
determining a touch type for the physical touch based on the processed capacitive image data.

2. The method of claim 1 wherein the step of processing the capacitive image data comprises transforming the capacitive image data to obtain one or more derivative images for the capacitive image.

3. The method of claim 2 wherein the step of transforming the capacitive image data comprises using at least one of a log transform, adaptive thresholding, binarization, image morphological operation, or convolution with Gaussian kernel to transform the capacitive image data.

4. The method of claim 1 wherein the step of processing the capacitive image data comprises extracting a region of the capacitive image representing the physical touch, the region including capacitive image data for locations where the physical touch occurs.

5. The method of claim 4 wherein the step of extracting the region of the capacitive image comprises isolating the region from other regions representing other physical touches.

6. The method of claim 1 wherein the step of processing the capacitive image data comprises removing noise from the capacitive image.

7. The method of claim 1 wherein the step of determining a touch type comprises:
extracting features from the capacitive image data; and
classifying the features to determine a touch type for the physical touch.

8. The method of claim 7 wherein the extracted features include at least one of a covariance matrix computed based on the capacitive image data, a ratio of elements of the covariance matrix to the total variance of the capacitive image data and one or more eigenvalues of the covariance matrix.

9. The method of claim 7 wherein the step of extracting features comprises:
extracting, in the capacitive image, a plurality of various-sized neighborhoods around a touch contact origin of the physical touch; and
computing at least one statistical feature based on the plurality of neighborhoods.

10. The method of claim 9 wherein the statistical feature includes at least one of a mean, range, standard deviation, dispersion, skewness and root mean square (RMS).

11. The method of claim 7 wherein the extracted features include at least one of a vector of individual capacitive image data and the total sum of the individual capacitive image data.

12. The method of claim 7 wherein the step of extracting features comprises:
fitting a multivariate Gaussian function over distribution for the capacitive image data; and
computing features associated with the Gaussian function.

13. The method of claim 7 wherein the step of extracting features comprises estimating a touch contact area based on the number of nonzero values in the capacitive image data.

14. The method of claim 13 further comprising computing at least one statistical feature over the nonzero values.

15. The method of claim 7 wherein the step of extracting features comprises:
extracting a boundary corresponding to the physical touch in the capacitive image based on a contour analysis; and
computing features associated with the boundary.

16. The method of claim 7 wherein the extracted features include at least one feature based on a location, shape, orientation, and/or size of the touch.

17. The method of claim 7 wherein the step of classifying the features comprises using at least one of a support vector machine, neural network, decision tree, naïve Bayes, random forest, elastic matching, template matching, k-means clustering, or logistic boosting to classify the features.

18. The method of claim 7 wherein the step of classifying the features comprises:
applying multiple classifiers to the features to obtain multiple classification results; and
combining the classification results through a voting scheme.

19. The method of claim 1 further comprising:
accessing sensor data for a sensor signal produced by the physical touch, the sensor data different than the capacitive image data;
extracting sensor features from the sensor data; and
determining a touch type for the physical touch based also on the extracted sensor features.

20. The method of claim 19 wherein the sensor data includes vibro-acoustic data caused by the physical touch.

21. The method of claim 1 wherein accessing the capacitive image is responsive to the occurrence of the physical touch on the touch-sensitive surface.

22. The method of claim 1 further comprising:
executing an action on the electronic device in response to the touch and touch type, wherein the same touch results in execution of a first action for a first touch type and results in execution of a second action for a second touch type.

23. The method of claim 1 wherein the touch-sensitive surface is a touch screen.

24. A machine-readable tangible storage medium having stored thereon data representing sequences of instructions, which when executed by an electronic device having a touch-sensitive surface, cause the electronic device to perform a method comprising the steps of:
accessing a capacitive image comprising capacitive image data corresponding to capacitances at a plurality of locations on the touch-sensitive surface, the capacitances varying in response to a physical touch on the touch-sensitive surface;
processing the capacitive image data; and
determining a touch type for the physical touch based on the processed capacitive image data.

25. An electronic device comprising:
a touch-sensitive surface;
means for accessing a capacitive image comprising capacitive image data corresponding to capacitances at a plurality of locations on the touch-sensitive surface, the capacitances varying in response to a physical touch on the touch-sensitive surface;
means for processing the capacitive image data; and
means for determining a touch type for the physical touch based on the processed capacitive image data.
